(19) United States
(12) Patent Application Publication
(10) Pub. No.: US 2010/0115810 A1
(43) Pub. Date: May 13, 2010

(54) LOOSE-LEAF CARD HOLDER

(76) Inventor: LAWRENCE MORERA, Beverly Hills, CA (US)

Correspondence Address: Law Office of Michael N. Cohen, P.C., 9025 Wilshire Blvd., Suite 301, Beverly Hills, CA, 90211, US

(21) Appl. No.: 12/268,752

(22) Filed: Nov. 11, 2008

(51) Int. Cl. G09F 19/00

(52) U.S. Cl. 40/537

(57) ABSTRACT

A loose-leaf card holder adapted for storing and displaying professionally graded sports cards is disclosed. The loose-leaf card holder comprises a holder body including a backing sheet having at least one backing lateral side edge and at least one backing transverse side bottom edge. The holder body further includes a plurality of front sheets. Each front sheet has at least one lateral side edge and at least one transverse side bottom edge. Each front sheet is being heat-sealed to the backing sheet with at least one backing lateral side edge and at least one backing transverse side bottom edge to form at least one pocket. Each pocket has a top loadable open-access end such that the professionally graded sports cards may be inserted into the pocket. The holder body further includes a binding portion having a plurality of binding holes.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to loose-leaf card holders, and more particularly to a loose-leaf card holder adapted for storing and displaying professionally graded sports cards.

### DISCUSSION OF RELATED ART

Card collectors often store sports cards in loose-leaf card holders that are bound together in a card storage book. A conventional card holder is adapted for holding a plurality of sports cards therein. However, the conventional loose-leaf card holders do not provide an adequate facility for storing and displaying professionally graded sports cards. Professionally graded sports cards are examined by a professional grader for determining its condition. Once the condition has been determined, the card is sonically sealed inside a protective tamper-proof holder with a tagged label for showing its certification number, manufacturer, grade, date, unique barcode and players' name for ensuring the card's protection and authenticity.

Several prior arts are known for storing and displaying sports cards. For example, U.S. Pat. No. 5,119,574 to King on Jun. 9, 1992 discloses a collector's album comprising a binder and display pages having at least one pocket for receiving collectible display items. Each display page includes transparent front and back panels with the front panels having pockets defined by recessed base surfaces and peripheral retaining walls. Retaining members are cooperative with the peripheral retaining walls to releasably retain display items and associated transparent display covers within the corresponding pockets. Such a device doesn't possess acid free archival quality for a long term display and protection of professionally graded sports cards.

One prior art device, taught in U.S. Pat. No. 5,323,553 to Candido on Jun. 28, 1994 discloses an album sleeve for storing and displaying baseball cards. The sleeve is created from a rectangular blank of transparent plastic film having three transverse fold lines whose parallel positions are such that when the blank is folded on the first line, it then defines a front panel overlying a rear panel. The second fold line defines a broad flap section which is folded over the back of the rear panel to complete the sleeve. The third fold line defines a narrow flap section that is folded down to form an expandable internal pocket. However, the pockets lack strong welds and don't possess adequate strength and space for accommodating professionally graded cards.

U.S. Pat. No. 5,651,202 to Hewitt on Jul. 29, 1997 provides a display system suitable for displaying and protecting card-like objects. The display system includes an expandable display device and a card holder. The expandable display includes a primary backing panel and a frame assembly providing a contiguous border around a periphery of the primary backing panel. The card holder includes a transparent first panel and a transparent second panel that selectively engages the first panel to hold the card-like object. Such a device doesn't facilitate users repeated access to the cards. The panels lack high clarity and may block or distort the appearance of the card.

Another prior art device, taught in U.S. Pat. No. 6,971,520 to Fulda on Dec. 6, 2005 discloses a flexible card holder and display which enables a plurality of cards to be attached, transported, displayed and stored. The card holder comprises a sheet of thin, tear-resistant material into which a plurality of slits have been cut. The slits are arranged to receive portions of the cards on the sheet. In such a device, the cards are loosely held in the slit. When the slit is manipulated as in turning the page, the card may then slip out off the open ends of the sleeve, and may get damaged.

Therefore, there is a need for an improved loose-leaf card holder that would have pockets with strong welds for preventing the card from falling out and allow users for repeatedly accessing their cards. Further, such a loose-leaf card holder would be made from a high clarity material and would possess acid free archival quality for storing and displaying professionally graded sports cards. Moreover, such a loose-leaf card holder would have adequate pocket size and strength for storing and displaying professionally graded sports cards. The present invention accomplishes these objectives.

### SUMMARY OF THE INVENTION

The present device is a loose-leaf card holder adapted for storing and displaying professionally graded sports cards. The loose-leaf card holder comprises a holder body including a backing sheet having at least one backing lateral side edge and at least one backing transverse side bottom edge. The holder body further includes a plurality of front sheets. Preferably, each front sheet has at least one lateral side edge and at least one transverse side bottom edge. Each front sheet is being heat-sealed to the backing sheet with at least one backing lateral side edge and at least one backing transverse bottom edge to form at least one pocket.

Each pocket being placed uniformly on the holder body has a top loadable open-access end such that the professionally graded sports cards can be inserted into the pocket. The holder body further includes a binding portion having a plurality of binding holes. The binding holes are formed with and extend from the at least one backing lateral side edge of the backing sheet.

The present invention is an improved loose-leaf card holder that has pockets with strong welds for preventing the card from falling out and facilitates users repeated access to the cards. Further, such a loose-leaf card holder is made from a high clarity material and possesses acid free archival quality for storing and displaying professionally graded cards. Moreover, such a loose-leaf card holder has adequate pocket size and strength for storing and displaying professionally graded sports cards. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a loose-leaf card holder for storing and displaying professionally graded sports cards;

FIG. 2 is a front view of the invention, illustrating the insertion of a professionally graded sports card into at least one pocket;

FIG. 3 is a side cross-sectional view of the invention, illustrating at least one pocket; and

FIG. 4 is a side cross-sectional view of the invention, illustrating an insertion of a professionally graded sports card into at least one pocket.

### DETAILED DESCRIPTION OF THE PREFERRED EMBODIMENT

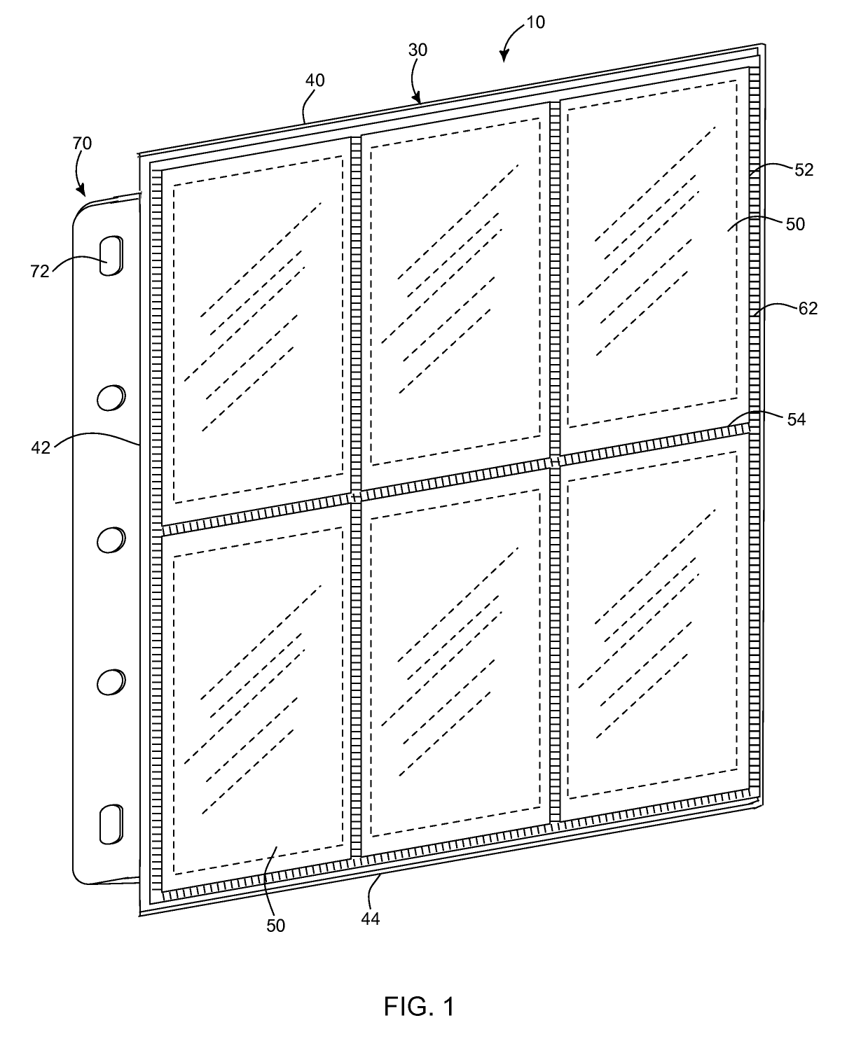

FIG. 1 is a perspective view of a loose-leaf card holder 10 adapted for storing and displaying a plurality of professionally graded sports cards 20. The loose-leaf card holder 10 for holding the professionally graded sports cards 20 comprises a holder body 30 including a backing sheet 40 having at least one backing lateral side edge 42 and at least one backing transverse side bottom edge 44 The holder body 30 further includes a plurality of front sheets 50. Preferably, each front sheet 50 has at least one lateral side edge 52 and at least one transverse side bottom edge 54. Each front sheet 50 is being heat-sealed to the backing sheet 40 with at least one lateral side edge 52 and at least one transverse side bottom edge 54 to form at least one pocket 60. The at least one pocket 60 is formed on the surface of the holder body 30. The at least one pocket 60 has a top loadable open-access end 80 for inserting the professionally graded card 20. The holder body 30 further includes a binding portion 70 having a plurality of binding holes 72. The binding holes 72 are formed with and extend from the at least one backing lateral side edge 42 of the backing sheet 40. Each loose-leaf card holder 10 fits custom made multiple-ring binders and may be bound together in a card storage book.

The holder body 30 may be substantially rectangular in shape. The holder body 30 generally possesses acid free archival quality for a long protection of the professionally graded sports cards 10. The backing sheet 40 and the plurality of front sheets 50 are generally transparent in nature. The backing sheet 40 and the plurality of front sheets 50 are generally made from a plastic fusible material. The plastic fusible material may be a poly-propylene or the like. The plastic fusible material generally possesses high clarity for the long term display of professionally graded sports cards 20.

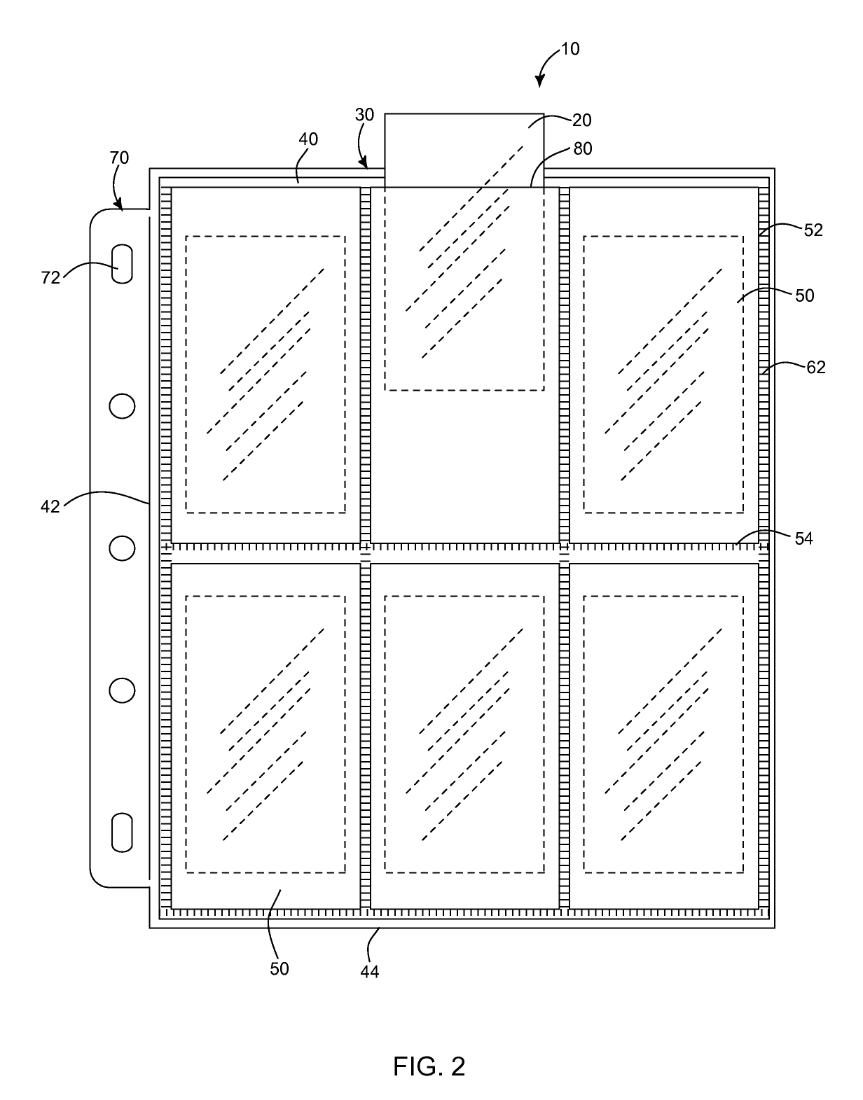

FIG. 2 shows a front view of a loose-leaf card holder 10 for storing and displaying professionally graded sports cards 20. Wherein the professionally graded sports card 20 is inserted into at least one pocket 60 of the loose-leaf card holder 10. The at least one pocket 60 has generally equal rectangular size. The at least one pockets 60 are placed uniformly on the holder body 30. Moreover, each pocket 60 may include a strong weld 62 and generally have adequate size and strength to store professionally graded sports cards 20.

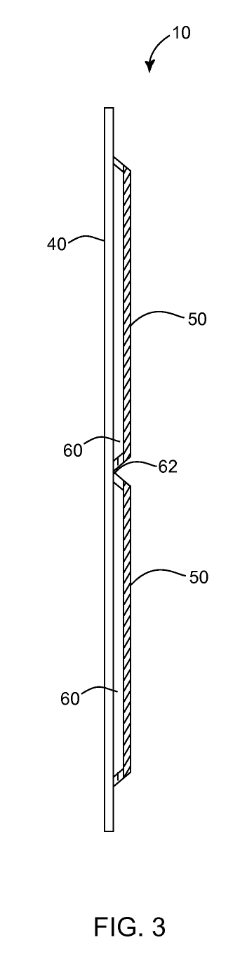

FIG. 3 is a side cross-sectional view of the loose-leaf card holder 10 with at least one pocket 60 without the professionally graded sports cards 20. At least one pocket 60 is formed by the heat-sealing of each front sheet 50 to the backing sheet 40 with at least one lateral side edge 52 and at least one transverse side bottom edge 54. Each pocket 60 has a top loadable open-access end 80 such that the cards 20 can be inserted into the pocket 60 by way of the open access end 80.

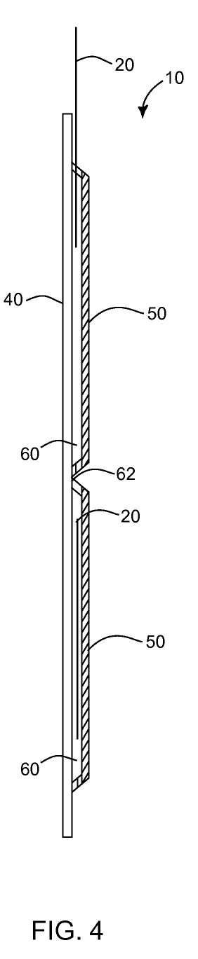

FIG. 4 shows a side cross-sectional view of the loose-leaf card holder 10. The sectional view illustrates the insertion of the professionally graded sports cards 20 into at least one pocket 60. The professionally graded sports cards 20 are inserted into at least one pocket 60 that is formed by the heat-sealing of each front sheet 50 to the backing sheet 40 with at least one lateral side edge 52 and at least one transverse side bottom edge 54.

While a particular form of the invention has been illustrated and described, it will be apparent that various modifications can be made without departing from the spirit and scope of the invention. For example, the number of pockets may be changed, the pockets may be manufactured in various size and dimensions so as to accommodate cards with different sizes. Accordingly, it is not intended that the invention be limited, except as by the appended claims.

1. A loose-leaf card holder adapted for holding a plurality of professionally graded sports cards therein, comprising:
a holder body including a backing sheet having at least one backing lateral side edge and at least one backing transverse side bottom edge thereof and generally possesses acid free archival quality for a long term display and protection of the professionally graded sports cards;
a plurality of front sheets, each front sheet having at least one lateral side edge and at least one transverse side bottom edge, being heat-sealed to the backing sheet with the at least one backing lateral side edge and the at least one backing transverse side bottom edge to form at least one pocket that is uniformly spaced on the holder body and has adequate size and strength to accommodate the professionally graded sports cards;
a binding portion having a plurality of binding holes formed integrally with and extends from the at least one backing lateral side edge of the backing sheet; and
whereby each front sheet being heat-sealed with the backing sheet to form the at least one pocket having a top loadable open-access end for inserting the professionally graded sports cards.

2. The loose-leaf card holder of claim wherein the holder body is substantially rectangular.

3. (canceled)

4. The loose-leaf cad holder of claim 1 wherein the backing sheet and the plurality of front sheets are generally transparent.

5. The loose-leaf card holder of claim 1 wherein the hacking sheet and the front sheet are generally made from a plastic fusible material.

6. The loose-leaf card holder of claim S wherein the plastic fusible material may be poly-propylene.

7. The loose-leaf card holder of claim 5 wherein the plastic fusible material generally possess high clarity.

8. The loose-leaf card holder of claim 1 wherein the at least one pocket is generally equal rectangular size.

9. (canceled)

10. The loose-leaf card holder of claim 1 wherein the at least one pocket may include a strong weld.

11. (canceled)
